(19) United States
(12) Patent Application Publication
(10) Pub. No.: US 2025/0069367 A1
(43) Pub. Date: Feb. 27, 2025

(54) METHOD AND SYSTEM FOR COLLECTING CONTENTS

(71) Applicant: MOTOV CO., LTD., Incheon (KR)

(72) Inventors: Seong Hoon KIM, Sejong-si (KR); Moon Seok KO, Goyang-si (KR); Tae Shik HWANG, Seoul (KR); Jun Hyung PARK, Suwon-si (KR)

(73) Assignee: MOTOV CO., LTD., Incheon (KR)

(21) Appl. No.: 18/586,912

(22) Filed: Feb. 26, 2024

(30) Foreign Application Priority Data
Aug. 24, 2023 (KR) 10-2023-0111107

(51) Int. Cl. G06V 10/764; G06F 16/583; G06V 20/58; G06V 20/62

(52) U.S. Cl. CPC G06V 10/764; G06F 16/583; G06V 20/58; G06V 20/625

(57) ABSTRACT

A method for collecting contents performed by a content collection device is provided. The method may comprise acquiring a captured image, recognizing a first object included in the acquired captured image by inputting the captured image into an object recognition model, the first object being an advertisement type object, generating content classification information for the recognized first object, determining whether the first object has already been reported by using the content classification information and transmitting metadata for the first object to a server when it is determined that the first object is a new object that has not already been reported as a result of performing the determining of whether the first object has already been reported.

### CROSS-REFERENCE TO RELATED APPLICATION

This application claims priority from Korean Patent Application No. 10-2023-0111107 filed on Aug. 24, 2023 in the Korean Intellectual Property Office, and all the benefits accruing therefrom under 35 U.S.C. 119, the contents of which in its entirety are herein incorporated by reference.

### BACKGROUND

### 1. Technical Field

The present disclosure relates to a method and system for collecting contents, and more particularly, to a method and system for minimizing a collection of redundant contents. In addition, the present disclosure relates to a method of analyzing a current status of an advertising market using collected contents.

### 2. Description of the Related Art

In the outdoor advertising market, estimating the cost that competitors spend on outdoor advertising and determining how much money to invest in outdoor advertising may be an important marketing strategy. In the existing outdoor advertising market, there was no choice but to mobilize manpower to estimate the cost that competitors spend on outdoor advertising. In addition, even if a current status of outdoor advertisements of competitors is investigated by mobilizing manpower, it was not easy to identify redundant outdoor advertisements. If the redundant outdoor advertisements may not be objectively identified, it is impossible to accurately estimate the cost that competitors spend on outdoor advertising.

Therefore, a technology that automates an analysis of a status using mobile or fixed cameras instead of mobilizing manpower in analyzing the current status of outdoor advertisement is required, and at the same time, a technology that may present an objective current status of outdoor advertising by minimizing indiscriminate collection of redundant outdoor advertisements even if the analysis of the status of outdoor advertising is automated is required.

### SUMMARY

Aspects of the present disclosure provide a method and system for minimizing a collection of redundant advertising contents by recognizing an advertising content object and information about the object when collecting advertising contents using a content collection device.

Aspects of the present disclosure also provide accurate statistics by analyzing a current status of an outdoor advertising market through classification of advertising contents collected using a content collection device.

Aspects of the present disclosure also provide a method for analyzing a current status of an outdoor advertising market that alleviates a burden on a server that provides statistics on the current status of the outdoor advertising market by quickly performing classification of advertising contents collected using a content collection device.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to an aspect of the present disclosure, there is provided an event processing method performed by at least one computing device. The method may comprise acquiring a captured image, recognizing a first object included in the acquired captured image by inputting the captured image into an object recognition model, the first object being an advertisement type object, generating content classification information for the recognized first object, determining whether the first object has already been reported by using the content classification information and transmitting metadata for the first object to a server when it is determined that the first object is a new object that has not already been reported as a result of performing the determining of whether the first object has already been reported.

In some embodiments, the content collection device may be mounted on a mobility.

In some embodiments, the content classification information may include a media type of an advertising medium to which advertising content included in the first object is attached, placement information of the advertising content included in the first object on the advertising medium, and a geographical location of the advertising medium.

In some embodiments, placement information of the advertising content included in the first object on the advertising medium may indicate a section in the advertising medium to which the advertising content is attached.

In some embodiments, the recognizing of the first object included in the acquired captured image by inputting the captured image into the object recognition model may include identifying a means of transportation to which advertising content included in the first object is attached.

In some embodiments, the identifying of the means of transportation to which the advertising content included in the first object is attached may include recognizing a vehicle license plate of the means of transportation and identifying the means of transportation by using the result of the recognition.

In some embodiments, the identifying of the means of transportation to which the advertising content included in the first object is attached may include identifying the means of transportation using real-time location information including movement information of the means of transportation.

In some embodiments, the identifying the means of transportation using the real-time location information including the movement information of the means of transportation may include identifying the means of transportation using the real-time location information only when the vehicle license plate of the means of transportation is not recognized.

In some embodiments, the determining of whether the first object has already been reported by using the content classification information may include querying an advertisement item stored in an advertisement database, comparing the metadata for the first object and the advertisement item as a result of performing the querying of the advertisement item and determining that the first object has not already been reported only when the metadata for the first object and the advertisement item do not match as a result of performing the comparing of the metadata for the first object and the advertisement item.

In some embodiments, the metadata for the first object may include an image recognized in the first object and the content classification information.

According to another aspect of the present disclosure, there is provided a method for analyzing a current status of an advertising market performed by a server. The method may comprise receiving, from a content collection device, a first image of a first object recognized by inputting a captured image captured by the content collection device into an object recognition model, extracting a first vector of the first image by inputting the received first image into a content analysis model and using data output from the content analysis model, determining whether an advertisement item including an image recognized as being identical to the first image exists among advertisement items stored in an advertisement database, using the first vector, increasing the cumulative number of advertisements for the advertisement item including the image recognized as being identical to the first image, when the advertisement item including the image recognized as being identical to the first image exists and generating a new advertisement item including the first image and the first vector and inserting the new advertisement item into the advertisement database, when the advertisement item including the image recognized as being identical to the first image does not exist.

In some embodiments, the determining of whether the advertisement item including the image recognized as being identical to the first image exists among the advertisement items stored in the advertisement database, using the first vector may include calculating similarity between image vectors included in the advertisement items and the first vector and determining that the advertisement item including the image recognized as being identical to the first image exists, only when a first advertisement item including a vector whose similarity to the first vector is within a preset range among the image vectors included in the advertisement items is identified, as a result of performing the calculating of the similarity.

In some embodiments, the calculating of the similarity between the image vectors included in the advertisement items and the first vector may include extracting a preset number of second advertisement items from the advertisement database in the order in which the advertisement items were recently inserted into the advertisement database, among the advertisement items and calculating similarity between image vectors included in the extracted second advertisement items and the first vector.

In some embodiments, the receiving of, from the content collection device, the first image of the first object recognized by inputting the captured image captured by the content collection device into the object recognition model may include receiving information about the type of advertising medium to which advertising content included in the first object is attached, and the calculating of the similarity between the image vectors included in the advertisement items and the first vector may include extracting third advertisement items attached to the same type of advertising medium as the advertising medium to which the advertising content included in the first object is attached from the advertisement database by using the received information about the type of advertising medium to which the advertising content included in the first object is attached and calculating similarity between image vectors included in the extracted third advertisement items and the first vector.

According to still another aspect of the present closure, there is provided a system for collecting contents. The system may comprise a photographing device, a communication interface, a memory into which a computer program is loaded; and one or more processors on which the computer program is executed, wherein the computer program includes instructions for performing: an operation of acquiring a captured image from the photographing device, an operation of recognizing a first object included in the acquired captured image by inputting the captured image into an object recognition model, the first object being an advertisement type object, an operation of generating content classification information for the recognized first object, an operation of determining whether the first object has already been reported by using the content classification information and an operation of transmitting metadata for the first object to a server when it is determined that the first object is a new object that has not already been reported as a result of performing the determining of whether the first object has already been reported.

In some embodiments, the content classification information may include a media type of an advertising medium to which advertising content included in the first object is attached, placement information of the advertising content included in the first object on the advertising medium, and a geographical location of the advertising medium.

In some embodiments, the operation of recognizing the first object included in the acquired captured image by inputting the captured image into the object recognition model may include an operation of identifying a means of transportation to which advertising content included in the first object is attached.

In some embodiments, the operation of identifying the means of transportation to which the advertising content included in the first object is attached may include an operation of recognizing a vehicle license plate of the means of transportation and an operation of identifying the means of transportation by using the result of the recognition.

In some embodiments, the operation of identifying the means of transportation to which the advertising content included in the first object is attached may include an operation of identifying the means of transportation using real-time location information including movement information of the means of transportation.

In some embodiments, the operation of identifying the means of transportation using the real-time location information including the movement information of the means of transportation may include an operation of identifying the means of transportation using the real-time location information only when the vehicle license plate of the means of transportation is not recognized.

According to the present exemplary embodiment, the collection of redundant advertising contents may be minimized by recognizing the advertising content object and the information about the object when collecting the advertising contents using the content collection device, thereby providing accurate statistics on the current status of the outdoor advertising market.

According to the present exemplary embodiment, accurate statistics may be provided by analyzing the current stature of the outdoor advertising market through classification of advertising contents collected using the content collection device.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a configuration diagram of a system for analyzing a current status of an advertising market according to some exemplary embodiments of the present disclosure;

FIG. 2 is a flowchart of a method for collecting contents according to another exemplary embodiment of the present disclosure;

FIG. 3 is an illustrative diagram of a method for recognizing an object according to a method for collecting contents according to still another exemplary embodiment of the present disclosure;

FIG. 4 is a diagram illustrating a content collection device according to still another exemplary embodiment of the present disclosure;

FIG. 5 is an illustrative diagram of a method for recognizing an object displaying content classification information according to still another exemplary embodiment of the present disclosure;

FIG. 6 is a flowchart for describing some operations related to the method for collecting contents according to still another exemplary embodiment of the present disclosure;

FIG. 7 is a flowchart for describing some operations related to the method for collecting contents according to still another exemplary embodiment of the present disclosure;

FIG. 8 is a flowchart of a method for analyzing a current status of an advertising market according to some exemplary embodiments of the present disclosure;

FIG. 9 is an illustrative diagram of advertisement items stored according to the method for analyzing the current status of the advertising market according to another exemplary embodiment of the present disclosure;

FIGS. 10 to 12 are flowcharts for describing some operations related to a method for analyzing a current status of an advertising market according to still another exemplary embodiment of the present disclosure; and

FIG. 13 is a hardware configuration diagram of a computing system described in some exemplary embodiments of the present disclosure.

### DETAILED DESCRIPTION OF THE EMBODIMENTS

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Hereinafter, embodiments of the present disclosure will be described with reference to the attached drawings.

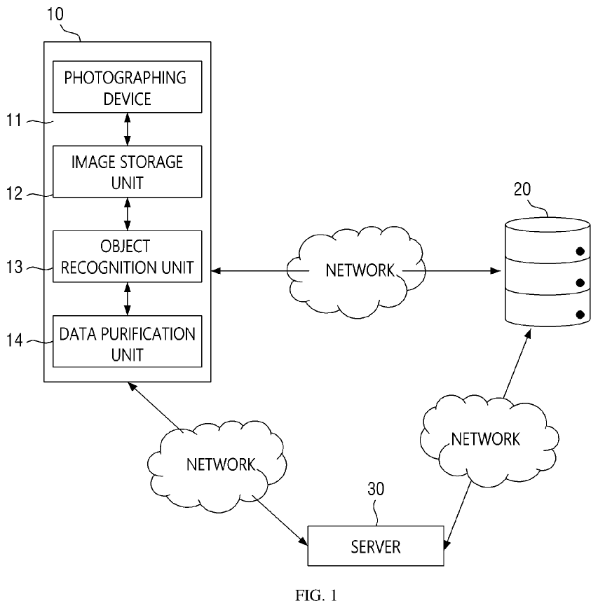

Hereinafter, the configuration and operation of a system for analyzing a current status of an advertising market according to an exemplary embodiment of the present disclosure will be described with reference to FIG. 1.

FIG. 1 is a configuration diagram of a system for analyzing a current status of an advertising market according to some exemplary embodiments of the present disclosure. Referring to FIG. 1, the system for analyzing the current status of the advertising market according to some exemplary embodiments of the present disclosure includes a content collection device 10, an advertisement database 20, and a server 30, and the content collection device 10, the advertisement database 20, and the server 30 are connected through a network.

The content collection device 10 may be a device that has computing power to capture images and recognize advertisement-type objects from the captured images. For example, the content collection device 10 may be a computing device with a mobile camera, a computing device with a fixed camera, or a smartphone with a camera.

The content collection device 10 may include a photographing device 11, an image storage unit 12, an object recognition unit 13, and a data purification unit 14. The photographing device 11 is a device mounted inside the content collection device 10, and may capture images at preset intervals and transmit the captured images to the image storage unit 12.

The image storage unit 12 that receives the images from the photographing device 11 temporarily stores the captured images in a storage space.

The object recognition unit 13 may recognize an advertisement type object included in the captured image by inputting the captured image stored in the image storage unit 12 into an object recognition model. In addition, the object recognition unit 13 may recognize a vehicle license plate of the means of transportation included in the captured image.

When the object recognition unit 13 recognizes the advertisement type object included in the captured image, the object recognition unit 13 may request the data purification unit 14 to generate content classification information about the recognized advertisement type object. The data purification unit 14 may generate the content classification information about the recognized advertisement type object and generate metadata about the recognized advertisement type about. The metadata about the recognized advertisement type object may include image and content classification information of the recognized advertisement type object. The metadata about the recognized advertisement type object is temporarily stored in an internal storage device provided in the content collection device 10.

When the content collection device 10 generates and stores the metadata about the recognized advertisement type object, the content collection device 10 may query the advertisement database 20 through a network to determine whether the recognized advertisement type object has been reported.

The advertisement database 20 may be a storage device that stores information about advertisement items. The advertisement items may be classified according to advertiser and advertising material. Since the advertisement database 20 stores the advertisement items separately, a current status of an outdoor advertising market may be easily analyzed.

The server 30 receives metadata about a first object recognized as an advertisement from the content collection device 10, and may analyze contents using the metadata about the received first object and store the analyzed contents in the advertisement database 20 for each advertisement item. As the content collection device 10 primarily filters redundant advertising contents using the content classification information, and the server 30 analyzes the filtered advertising contents and stores the analyzed contents in the advertisement database 20 for each advertisement item, the burden on the server that provides statistics on the current status of the outdoor advertising market may be alleviated.

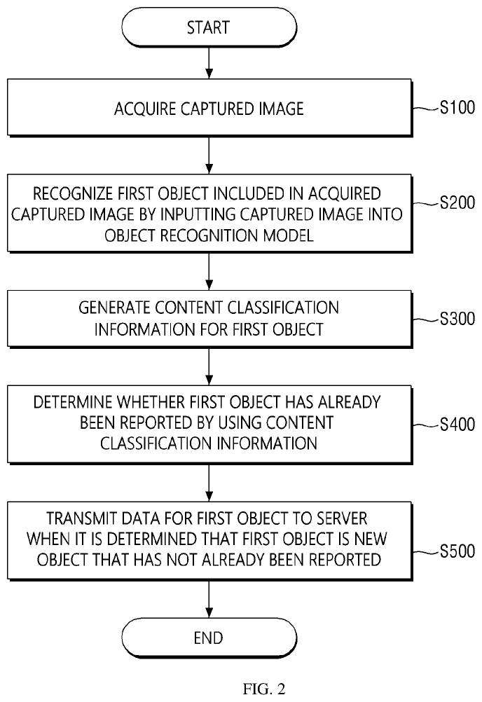

In the present disclosure, when the content collection device 10 moves and captures images including outdoor advertisements, multiple captured images may include redundant outdoor advertisements. Accordingly, it is need to minimize a collection of the redundant advertising contents included in the multiple images. Hereinafter, a method for minimizing the collection of redundant advertising contents included in multiple images will be described with reference to FIGS. 2 to 7.

Hereinafter, a method for collecting contents according to another exemplary embodiment of the present disclosure will be described with reference to FIG. 2.

FIG. 2 is a flowchart of a method for collecting contents according to some exemplary embodiments of the present disclosure.

Referring to FIG. 2, the content collection device 10 may acquire a captured image by capturing an image including advertising contents attached to a building, bus, taxi, etc., using the photographing device 11 built into the content collection device 10 (S100). In this case, the photographing device 11 captures images according to a preset cycle.

When the content collection device 10 is a mobile terminal, the image captured by the photographing device 11 may be shaken as the content collection device 10 moves, making it difficult to recognize objects in the image. In this case, the photographing device 11 may perform correction on an image whose focus is shaken so that various objects included in the image may be accurately recognized. The image storage unit 12 may store an image on which the correction has been performed by the photographing device 11.

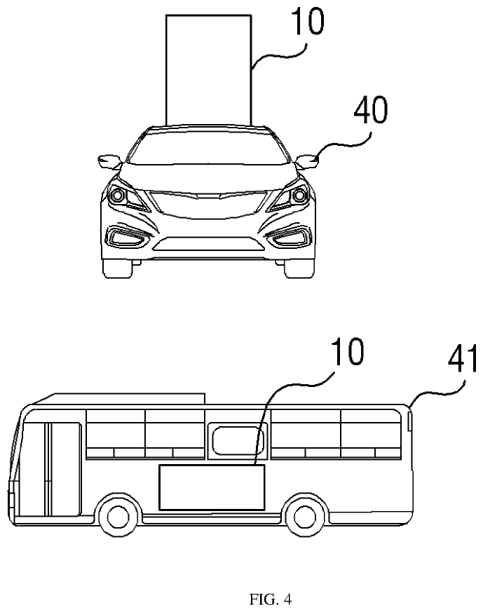

In an exemplary embodiment, the content collection device 10 may be mounted on a mobility. Referring to FIG. 4, the content collection device 10 may be a device that is attached to a mobility such as a taxi 40 or a bus 41 and captures images according to a preset cycle.

According to the present exemplary embodiment, as the mobility such as the taxi 40 or the bus 41 moves and captures images including outdoor advertisements, there is no need to mobilize manpower to acquire the captured images for analyzing the current stature of the outdoor advertising market.

The method for minimizing the collection of redundant advertising contents included in the multiple images will be described with reference to FIG. 2 again.

When the photographing device 11 acquires a captured image by capturing an image including advertising contents, the photographing device 11 may transmit the acquired captured image to the image storage unit 12. The image storage unit 12 may temporarily store the received captured image in a storage space.

The object recognition unit 13 may recognize a first object, which is an advertisement-type object, included in the captured image by inputting the captured image stored in the image storage unit 12 into an object recognition model (S200). The object recognition unit 13 may additionally recognize not only the first object but also information about where the advertising content included in the first object is placed on an advertising medium.

The object recognition unit 13 may recognize the first object using You Only Look Once (YOLO) as the object recognition model. YOLO is the most representative model among object detection technologies, and since those skilled in the art will already be familiar with YOLO, a detailed description thereof will be omitted. Meanwhile, the object recognition model used to recognize the first object is not limited to YOLO.

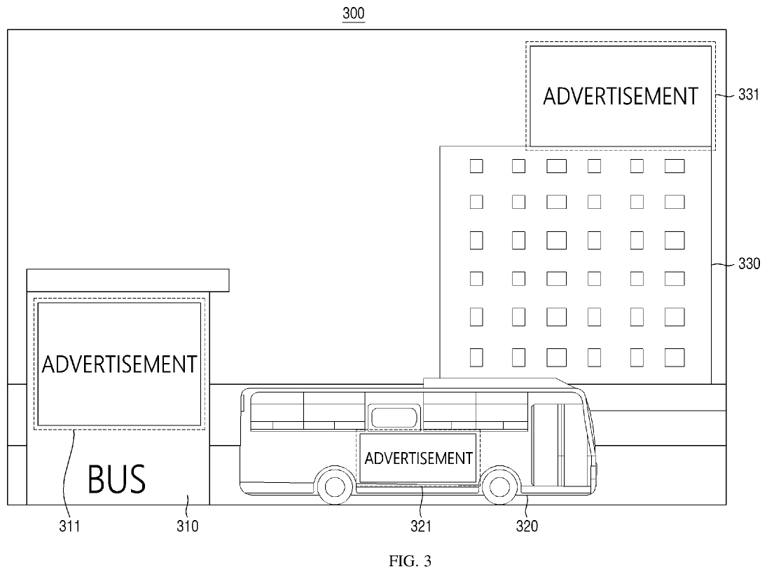

Hereinafter, a method for recognizing an object according to a method for collecting contents according to still another exemplary embodiment of the present disclosure will be described with reference to FIG. 3.

FIG. 3 is an illustrative diagram of a method for recognizing an object according to a method for collecting contents according to still another exemplary embodiment of the present disclosure.

Referring to FIG. 3, when the object recognition unit 13 inputs the captured image 300 into the object recognition model, objects 311, 321, and 331 including advertising contents included in the image 300 may be recognized. For example, the object recognition unit 13 may recognize, by the object recognition model, a bus shelter 310, an object 311 including advertising content installed on the bus shelter 310, a bus 320, an object 321 including advertising content installed on a side of the bus 320, a building 330, and an object 331 including advertising content installed on an outdoor electronic display board on a rooftop of the building 330, in the image 300.

In the process of the object recognition unit 13 recognizing the bus shelter 310, the bus 320, and the building 330, information about the type of advertising medium to which the advertising content included in each object 311, 321, and 331 is attached and where the advertising content included in the object is placed on the advertising medium may be specified.

For example, the object recognition model may recognize that the object 311 is located on a first paper of the bus shelter 310, may recognize that the object 321 is located on a side billboard of the bus 320, and may recognize that the object 331 is located on the outdoor electronic display board on the rooftop of the building 330.

Through the above-mentioned process, when the object recognition unit 13 recognizes the first object included in the captured image, the object recognition unit 13 transmits to the data purification unit 14 the recognized first object, the type of advertising medium to which the advertising content included in the first object is attached, and placement information of the advertising content included in the first object on the advertising medium.

Thereafter, the data purification unit 14 may generate first content classification information for the received first object (S300). The first content classification information may include the media type of the advertising medium to which the advertising content included in the first object is attached, the placement of the advertising content included in the first object on the advertising medium, and information about a geographical location of the advertising medium.

The media type of the advertising medium to which the advertising content included in the first object is attached may be either a video advertisement or a static image advertisement.

When the media type of the advertising medium is a static image advertisement, the advertising content displayed on the advertising medium does not change for a certain period of time and displays the same advertising content. In this case, when the content collection device 10 collects an image including advertising content of the corresponding advertising medium, if it is determined that an object recognized by an object recognition unit of a first content collection device from the image collected by the photographing device is the same as an object already recognized by an object recognition unit of another second content collection device from the image collected by the photographing device, the first content collection device may determine the corresponding object to be an object including the content that has already been collected and may not perform analysis on the corresponding object.

On the other hand, when the media type of the advertising medium is a video advertisement, the advertising content displayed on the advertising medium may change according to a preset period. The preset period is determined by an advertising agency operating the advertising medium, and may be a period of every hour, but is not limited thereto. In this case, if it is determined that an object recognized by an object recognition unit of a first content collection device from the image collected by the photographing device is the same as an object already recognized by an object recognition unit of another second content collection device from the image collected by the photographing device, the first content collection device may determine the corresponding object to be an object including the content that has already been collected and may not perform analysis on the corresponding object. However, if it is determined that the object recognized by the object recognition unit of the first content collection device from the image collected by the photographing device is an object different from the object recognized by the object recognition unit of another second content collection device from the image collected by the photographing device, the first content collection device needs to perform analysis on the corresponding object.

According to the present exemplary embodiment, the data purification unit 14 may classify the media type of the advertising medium to which the advertising content included in the first object is attached into either a video advertisement or a static image advertisement. Therefore, according to the present exemplary embodiment, when the media type of the advertising medium is the static image advertisement, the burden on the content collection device 10 that performs object analysis and the server 30 that performs content analysis may be alleviated because there is no need to analyze the advertising content displayed on the advertising medium during the period when the advertising medium displays the same content.

As described above, the placement information on advertising media of the advertising content included in the first object may be recognized by the object recognition model.

The placement information of the advertising content included in the first object on the advertising medium may indicate a section in the advertising medium to which the advertising content included in the first object is attached. There may be various sections on the advertising medium to which the advertising content may be attached, and various advertising contents may be attached to each section. For example, first advertising content with advertiser A and advertising material X may be attached to a first paper billboard of the bus shelter in the captured image, and second advertising content with advertiser A and advertising material X may also be attached to a second paper billboard of the bus shelter in the captured image. An advertisement with advertiser A and advertising material X is attached to both the first and second paper billboards, but since the first advertising content and the second advertising content are distinct advertisements when analyzing the current status of the outdoor advertising market, the first advertising content and the second advertising content need to be recognized as different objects.

According to the present exemplary embodiment, by the placement information of the advertising content included in the first object on the advertising medium displaying and specifying the section to which the advertising content is attached, it may help determine whether the advertising content included in the first object has been collected redundantly.

The information about the geographical location of the advertising medium may be determined by collecting a location of the content collection device 10 at the time the content collection device 10 captures the image. The location of the content collection device 10 may be determined using GPS data recorded by a GPS system mounted within the content collection device 10.

The data purification unit 14 may generate first content classification information for the first object by collecting the media type of the advertising medium to which the advertising content included in the first object is attached, the placement of the advertising content included in the first object on the advertising medium, and the information about the geographical location of the advertising medium.

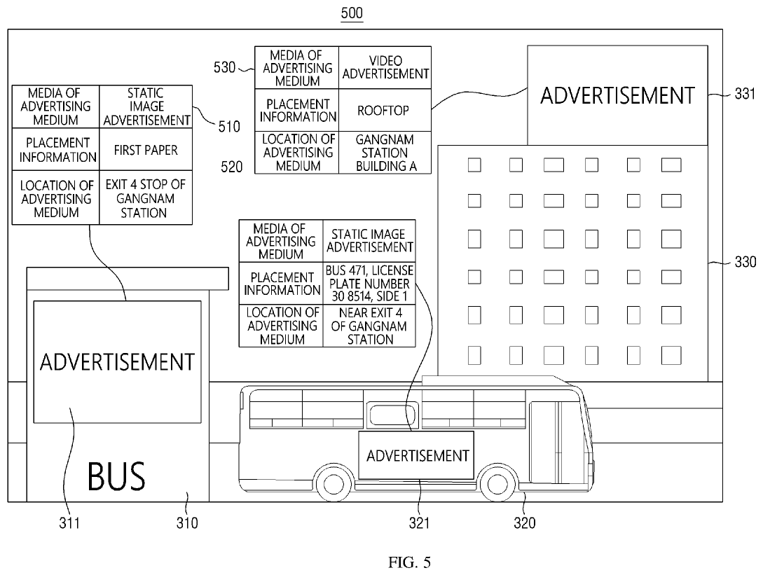

Hereinafter, a method by which the data purification unit 14 generates first content classification information for a first object will be described in detail with reference to FIG. 5. FIG. 5 is an illustrative diagram of a method for recognizing an object displaying content classification information according to still another exemplary embodiment of the present disclosure.

Referring to FIG. 5, an image 500 includes the bus shelter 310, the object 311 including advertising content installed on the bus shelter 310, the bus 320, the object 321 including advertising content installed on a side of the bus 320, the building 330, and the object 331 including advertising content installed on the outdoor electronic display board on the rooftop of the building 330, as illustrated in FIG. 3.

The data purification unit 14 may generate content classification information for the object 311 including advertising content installed on the bus shelter 310 and store the content classification information as metadata for the object 311. For example, the data purification unit 14 may store first content classification information 510 of the object 311 including advertising content installed on the bus shelter 310, as the media type of the advertising medium to which the advertising content including the object 311 is attached being a static image advertisement, the placement information of the advertising content included in the object 311 on the advertising medium being the first paper of the bus shelter, and the geographical location of the advertising medium being Exit 4 stop of Gangnam Station, as illustrated in FIG. 5.

Likewise, the data purification unit 14 may generate content classification information for the object 321 including advertising content installed on the bus 320 and store the content classification information as metadata for the object 321. For example, the data purification unit 14 may store first content classification information 520 of the object 321 including advertising content installed on the bus 320, as the media type of the advertising medium to which the advertising content including the object 321 is attached being a static image advertisement, the placement information of the advertising content included in the object 321 on the advertising medium being Bus 471, License plate number 30 8514, Side 1, and the geographical location of the advertising medium being near Exit 4 of Gangnam Station, as illustrated in FIG. 5.

In the case of a means of transportation such as a bus, identifying the means of transportation to which the first object is attached and specifying the advertising content attached to the identified means of transportation may be helpful in determining whether the corresponding advertising content has been collected redundantly. A method for identifying the means of transportation to which the first object is attached will be described in detail later, and a detailed description thereof will be omitted here.

Finally, the data purification unit 14 may generate content classification information for the object 331 including advertising content installed on the building 330 and store the content classification information as metadata for the object 331. For example, the data purification unit 14 may store first content classification information 530 of the object 331 including advertising content installed on the bus 330, as the media type of the advertising medium to which the advertising content including the object 331 is attached being a video advertisement, the placement information of the advertising content on the advertising medium being the outdoor electronic display board on the rooftop, and the geographical location of the advertising medium being Gangnam Station Building A, as illustrated in FIG. 5.

According to the present exemplary embodiment, generating the content classification information for the first object recognized from the captured image and using the above-mentioned information to minimize the collection of redundant advertising contents may contribute to providing accurate statistics on the current status of the advertising market.

Hereinafter, a method of determining whether advertising content included in the first object recognized from the image captured by the content collection device 10 has been redundantly collected by another content collection device 10 by identifying a means of transportation under the assumption that the first object included in the captured image acquired by the content collection device 10 through the photographing device 11 is an advertisement-type object attached to the means of transportation will be described.

The content collection device 10 inputting the captured image acquired using the photographing device 11 into the object recognition model to recognize the first object included in the acquired captured image may include identifying the means of transportation to which the advertising content included in the first object is attached. The means of transportation to which the advertising content included in the first object is attached may be a means of transportation such as a bus or taxi.

According to the present exemplary embodiment, as the content collection device 10 identifies the means of transportation to which the advertising content included in the first object is attached, it is possible to easily specify what advertising content is attached to the corresponding means of transportation, and the content collection device 10 may easily determine whether advertising content attached to the corresponding means of transportation has already been collected by another content collection device.

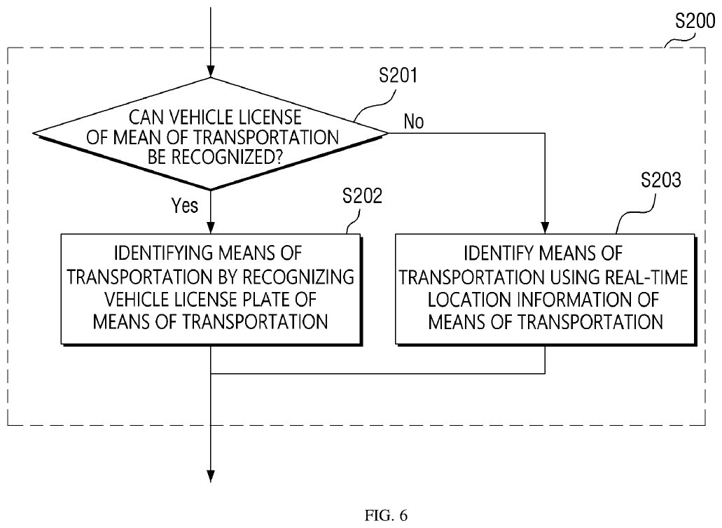

Hereinafter, a method by which the content collection device 10 identifies a means of transportation to which advertising content included in a first object is attached will be described with reference to FIG. 6. FIG. 6 is a flowchart for describing some operations related to the method for collecting contents according to still another exemplary embodiment of the present disclosure.

Referring to FIG. 6, if the object recognition unit 13 may recognize a vehicle license plate of the means of transportation from the acquired captured image, the object recognition unit 13 may recognize the vehicle license plate of the means of transportation, and may identify the means of transportation using the recognized vehicle license plate (S202).

For example, the captured image may simultaneously include a portion where the license plate of the means of transportation is captured and a portion where the advertising content attached to the means of transportation is captured. In this case, when the object recognition unit 13 inputs the above-mentioned captured image into the object recognition model, the object recognition model may recognize the advertising content attached to the means of transportation as the first object, and at the same time recognize the license plate of the means of transportation and analyze the license plate to acquire a vehicle license plate number of the means of transportation. In this case, the vehicle license plate number of the means of transportation may be acquired by analyzing the license plate of the means of transportation recognized by the object recognition model using optical character recognition (OCR) technology.

Thereafter, the object recognition unit 13 may transmit information about the acquired vehicle license plate number of the means of transportation to the data purification unit 14. The data purification unit 14 may generate first content classification information for the first object, and store information about the received vehicle license plate number of the means of transportation together in the generated first content classification information.

According to the present exemplary embodiment, the vehicle license plate number of the means of transportation to which the advertising content included in the first object is attached may be stored in the first content classification information. Therefore, according to the present exemplary embodiment, when the first object recognized by the content collection device 10 from the captured image is an advertisement type object attached to the means of transportation, the content collection device 10 may easily determine whether the first object including the advertising content attached to the corresponding means of transportation has been redundantly reported by querying the vehicle license plate number of the means of transportation included in the first content classification information in determining whether the first object has already been reported to the advertisement database 20.

Meanwhile, as described above, there may be a case in which the content collection device 10 may not recognize the vehicle license plate of the means of transportation from the captured image (S201). In this case, the content collection device 10 may use real-time location information including movement information of the means of transportation to identify the means of transportation (S203). For example, if the means of transportation to which the advertising content included in the first object is attached is a bus, the object recognition unit 13 may recognize a route number of the corresponding bus from the captured image. In this case, the content collection device 10 may determine a location of the content collection device 10 using a GPS sensor built into the content collection device 10, etc., and the object recognition unit 13 may specify a vehicle license plate number of the bus passing near the content collection device 10 by querying real-time location information including movement information for the bus passing that location based on the identified location. The object recognition unit 13 may transmit information about the specified vehicle license plate number of the bus to the data purification unit 14. The data purification unit 14 may generate first content classification information for the first object, and store information about the received vehicle license plate number of the means of transportation together in the generated first content classification information.

According to the present exemplary embodiment, when the first object recognized from the captured image acquired by the content collection device 10 through the photographing device 11 is an advertisement type object attached to the means of transportation, the content collection device 10 may easily determine whether the first object including the advertising content attached to the corresponding means of transportation has been redundantly reported by querying the vehicle license plate number of the means of transportation included in the first content classification information in determining whether the first object has already been reported to the advertisement database 20.

The method for minimizing the collection of redundant advertising contents included in the multiple images will be described with reference to FIG. 2 again.

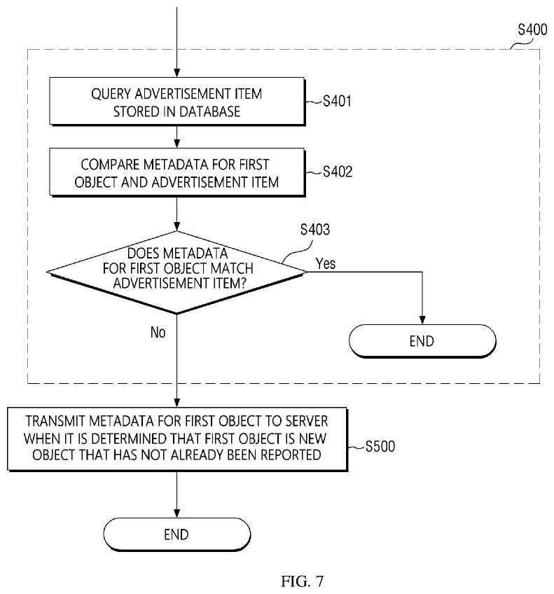

Referring to FIG. 2, if the data purification unit 14 generates and stores first content classification information for the recognized first object, the data purification unit 14 may determine whether the first object has already been reported by querying whether the first object has already been reported to the advertisement database 20 using the stored first content classification information (S400). A method by which the data purification unit 14 determines whether the first object has already been reported will be described with reference to FIG. 7. FIG. 7 is a flowchart for describing some operations related to the method for collecting contents according to still another exemplary embodiment of the present disclosure.

Referring to FIG. 7, the data purification unit 14 may query advertisement items stored in the advertisement database 20 (S401). The advertisement items stored in the advertisement database 20 are advertising content identified by the server 30 as being from different advertisers and advertising materials and stored in the advertisement database, and may include an image of the advertising content, a vector representing the image of the advertising content, the cumulative number of advertisements for the advertising content, content classification information, and information about the advertiser and advertising material.

Thereafter, the data purification unit 14 may compare the metadata for the first object recognized by the object recognition unit 13 with the previously queried advertisement item (S402). The metadata for the first object may include an image recognized from the first object and content classification information for the first object. That is, the data purification unit 14 may compare the image recognized from the first object with image information stored in the advertisement item, and compare the content classification information for the first object with the content classification information stored in the advertisement item, respectively.

The data purification unit 14 may determine that the first object has not been previously reported to the advertisement database 20 only when the metadata for the first object and the advertisement item do not match (S403). If the image recognized from the first object matches the image information stored in the advertisement item and the content classification information for the first object matches the content classification information stored in the advertisement item, the data purification unit 14 may determine that the first object has already been reported to the advertisement database 20, may not transmit the metadata for the first object to the server 30, and may terminate an analysis task for the first object.

On the other hand, the content classification information for the first object may not match the content classification information stored in the advertisement item, or the image recognized from the first object may not match the image information stored in the advertisement item. In this case, the data purification unit 14 may determine that the first object is a new object that has not been already reported to the advertisement database 20, and may transmit the metadata for the first object to the server 30 (S500).

According to the present exemplary embodiment, when the media type of the advertising medium to which the advertising content included in the first object is attached is a video advertisement, the advertising object including all advertising content displayed on the corresponding advertising medium may be analyzed without exception even if the advertising content displayed on the corresponding advertising medium changes according to a preset cycle.

In addition, according to the present exemplary embodiment, as the content collection device 10 primarily filters the redundant advertising contents using the content classification information, and the server 30 analyzes the filtered advertising contents and stores the analyzed contents in the advertisement database 20 for each advertisement item, the burden on the server that provides statistics on the current status of the outdoor advertising market may be alleviated.

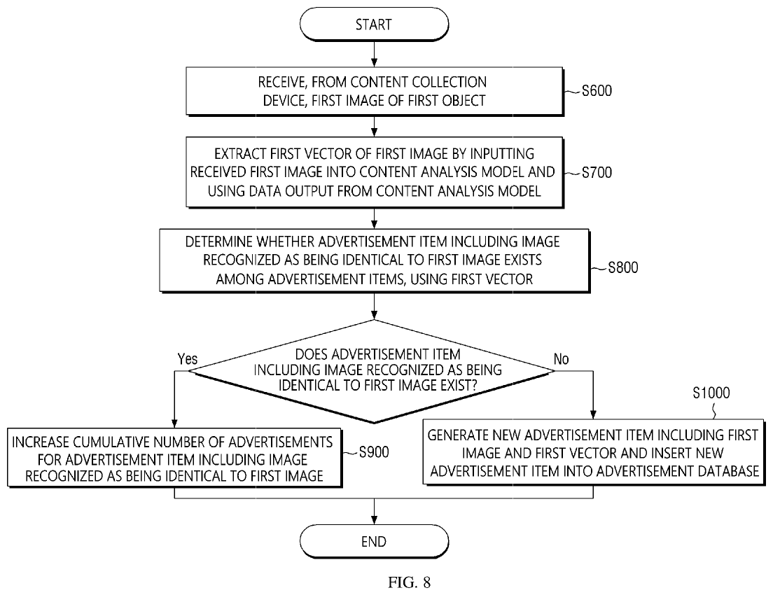

Hereinafter, a method of providing statistics on the current status of the outdoor advertising market for each advertisement item by which the content collection device 10 first filters the redundant advertising contents and then the server 30 analyzes the filtered advertising contents will be described with reference to FIGS. 8 to 12.

FIG. 8 is a flowchart of a method for analyzing the current status of the advertising market according to some exemplary embodiments of the present disclosure.

Referring to FIG. 8, the server 30 may receive, from the content collection device 10, a first image, which is an image of the first object of the advertisement type recognized by inputting the captured image captured by the content collection device 10 into the object recognition model (S600).

Thereafter, the server 30 may input the received first image into a content analysis model and extract a first vector representing the first image as a vector value using data output from the content analysis model (S700). In this case, the server 30 may extract the first vector using a contrastive language-image pre-training (CLIP) model as the content analysis model. The CLIP model is a model that may process both the image and text and vectorize the image and text. Since those skilled in the art will already be familiar with the CLIP model, a detailed description thereof will be omitted. Meanwhile, the content analysis model used to extract the first vector is not limited to the CLIP model.

Thereafter, the server 30 may determine whether an advertisement item including an image recognized as being identical to the first image received from the content collection device 10 exists among the advertisement items stored in the advertisement database 20, using the extracted first vector (S800).

If the advertisement item including the image recognized as being identical to the first image exists in the advertisement database 20, the server 30 updates a current stature of advertisement of the advertisement item by increasing the cumulative number of advertisements of the advertisement item including the image recognized as being identical to the first image (S900).

If the advertisement item including the image recognized as identical to the first image does not exist in the advertisement database 20, the server 30 generates a new advertisement item including the first image and the first vector, and inserts the generated new advertisement item into the advertisement database 20 (S1000).

According to the present exemplary embodiment, as the server once again filters whether the collected advertising content is redundant regarding the advertising content collected using the content collection device, and counts the cumulative number of advertisements in the advertising content, it is possible to provide accurate statistics on the current status of the outdoor advertising market.

In the process of the server 30 identifying an advertisement item including the image recognized as identical to the image of the first object among the advertisement items stored in the advertisement database 20 using the first vector, an image and an image vector of advertising content included in advertisement items stored in the advertisement database 20 are used. The advertisement items stored in the advertisement database 20 include the image and the image vector of the advertising content, but may also include other information about the advertising content.

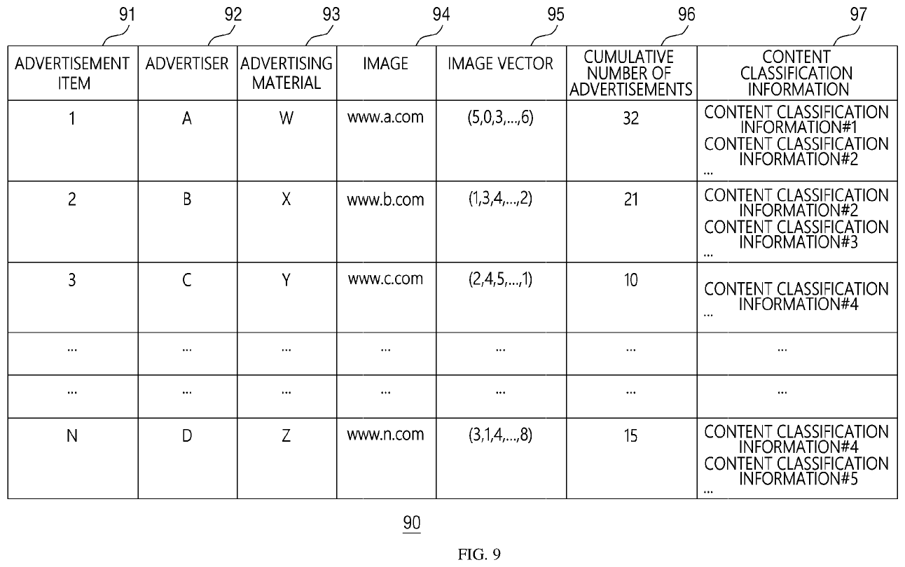

Hereinafter, information included in the advertisement items stored in the advertisement database 20 will be described with reference to FIG. 9. FIG. 9 is an illustrative diagram of advertisement items stored according to the method for analyzing the current status of the advertising market according to another exemplary embodiment of the present disclosure.

Referring to FIG. 9, the information included in the advertisement items may include the identification number 91 of an advertisement item, an advertiser 92 and an advertising material 93 of the advertisement item, an URL address 94 including an image of the advertising content of the corresponding advertisement item, an image vector 95, which represents the image of the advertising content of the corresponding advertisement item as a vector value, the cumulative number of advertisements 96 for the advertising content of the advertisement item, and content classification information 97 of the advertising content of the corresponding advertisement item.

The identification number 91 of the advertisement item may be assigned in the order in which the advertisement item is inserted into the advertisement database 20. As identification numbers 91 of the advertisement items are assigned in the order in which the advertisement items are inserted into the advertisement database 20, a vector similarity between advertisement items relatively recently inserted into the advertisement database 20 among the advertisement items and the first object may be preferentially calculated, in the process of the server 30 determining whether the advertisement item including the image recognized as being identical to the first image exists among the advertisement items stored in the advertisement database 20. Since the more recently inserted an advertisement item among the advertisement items is into the advertisement database 20, the higher the probability that it has more outdoor advertisements attached thereto, it is necessary for the server 30 to assign the identification numbers 91 of the advertisement items in the order in which the advertisement items are inserted into the advertisement database 20.

The advertiser 92 of the advertisement item may include information about an advertising agent who advertised the advertisement item. The advertising material 93 of the advertisement item may include information about a product that is a target of the advertising. In a situation where there is a shortage of advertisement items stored in the advertisement database 20, information about the advertiser 92 and the advertising material 93 may be manually entered by an administrator on the server 30 side.

The URL address 93 including the image of the advertising content of the advertisement item may display information about a URL that may be used to move to a page where the image of the advertising content appears.

The image vector 94, which represents the image of the advertising content of the advertisement item as the vector value may be acquired when the server 30 receives, from the content collection device 10, a first image of the first object recognized by the content collection device 10, and inputs the first image to the content analysis model to extract the first vector, in a process of inserting the new advertisement item into the advertisement database 20. By storing the image vector 93 in the information about the advertisement item, when a vector similarity with the first vector extracted from the first image of the first object received from the content collection device 10 is calculated later, the vector similarity may be more quickly calculated.

For the cumulative number of advertisements 96 for the advertising content of the advertisement item, as described above, if it is determined that the advertisement item including the image recognized as being identical to the first image exists in the advertisement database 20, the server 30 updates the current stature of advertisement of the advertisement item by increasing the cumulative number of advertisements of the advertisement item including the image recognized as being identical to the first image.

The content classification information 97 of the advertising content of the advertisement item is received from the content collection device 10. Since the same advertisement item may be advertised on multiple advertising media, there may be multiple pieces of content classification information for each advertisement item. Accordingly, the content classification information 97 of the advertising content of each advertisement item may have multiple pieces of content classification information. Since the content classification information is the same as described above, a detailed description thereof will be omitted here.

The information included in the advertisement item may include other information in addition to the data mentioned above, and is not limited to the data mentioned above.

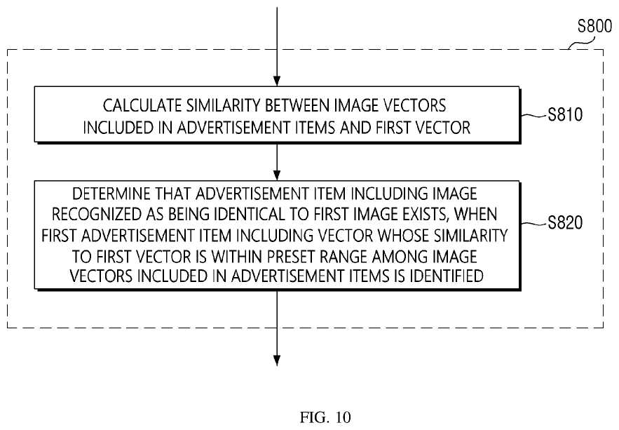

Next, a method for determining whether an advertisement item exists including an image recognized as being identical to the first image received from the content collection device 10 among the advertisement items stored in the advertisement database 20 will be described with reference to FIGS. 10 to 12. FIGS. 10 to 12 are flowcharts for describing some operations related to a method for analyzing a current status of an advertising market according to still another exemplary embodiment of the present disclosure.

Referring to FIG. 10, the determining of whether the advertisement item including the image recognized as being identical to the first image received from the content collection device 10 exists among the advertisement items stored in the advertisement database 20 may include calculating similarity between image vectors included in the advertisement items stored in the advertisement database 20 and the first vector extracted from the first image (S810), and determining, by the server 30, that the advertisement item including the image recognized as being identical to the first image exists, only when a first advertisement item including a vector whose similarity to the first vector is within a preset range among the image vectors included in the advertisement items is identified as a result of the server 30 performing a similarity calculation between the image vectors included in the advertisement items stored in the advertisement database 20 and the first vector extracted from the first image (S820).

The similarity calculation between the image vectors included in the advertisement items stored in the advertisement database 20 and the first vector extracted from the first image may use cosine similarity, but is not limited to the cosine similarity. When the server 30 uses the cosine similarity to calculate the similarity between the two vectors, the closer the calculated similarity between the two vectors is to 1, the higher the similarity between the two vectors is.

In the process of identifying, by the server 30, the first advertisement item including the vector whose similarity to the first vector is within the preset range among the image vectors included in the advertisement items, the more similar the vector is to the first vector, that is, the more similar the first image and the image included in first advertisement item is, the closer the calculated similarity will be to 1. Therefore, the range of the calculated similarity will be a decimal close to 1, but may be set differently depending on the situation.

There may be a case where there are multiple first advertisement items including vectors whose similarity to the first vector is within a preset range. In this case, the server 30 guides an administrator terminal to select the advertisement item including the image recognized as being identical to the first image by transmitting the first image and the images included in the multiple first advertisement items to the administrator terminal. Thereafter, the server 30 may determine that the advertisement item selected by the administrator terminal is the advertisement item including the image recognized as being identical to the first image.

According to the present exemplary embodiment, the content collection device 10 may primarily filter the redundant advertising contents, and the server 30 may check once again whether the primarily filtered advertising content has been redundantly collected using the vector extracted using the content analysis model. Therefore, according to the present exemplary embodiment, it is possible to provide objective statistics on the current status of the outdoor advertising market.

In the process of the server 30 calculating the similarity between the image vectors included in the advertisement items and the first vector, calculating the similarity between the image vectors included in all advertisement items and the first vector may be less efficient in terms of time. Therefore, a method is required in which the server 30 may select image vectors included in the advertisement items and calculate the similarity between the selected image vectors and the first vector.

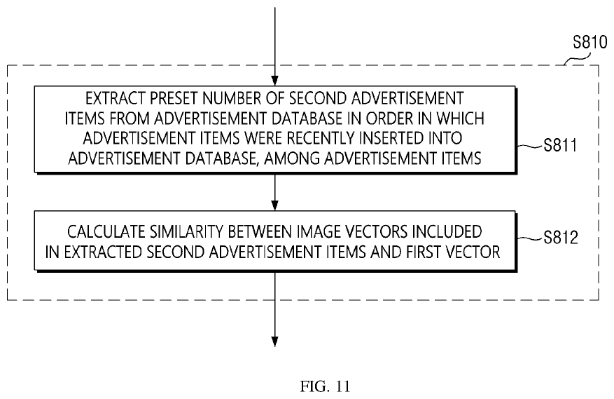

Referring to FIG. 11, when the server 30 calculates the similarity between the image vectors included in the advertisement items and the first vector, the server 30 may extract a preset number of second advertisement items from the advertisement database 20 in the order in which the advertisement items were recently inserted into the advertisement database 20 among the advertisement items (S811), and may calculate a similarity between image vectors included in the extracted second advertisement items and the first vector (S812). As described above, the insertion order between the advertisement items may be identified by the identification number 91 of each advertisement item. Since the more recently inserted an advertisement item among the advertisement items is into the advertisement database 20, the higher the probability that it has more outdoor advertisements attached thereto, the server 30 extracts a preset number of second advertisement items from the advertisement database 20 in the order in which the advertisement items were recently inserted into the advertisement database 20 and calculates the similarity between the extracted second advertisement items and the first vector, as described above. It is obvious that the number of extracted second advertisement items may be set differently depending on the situation.

According to the present exemplary embodiment, in the process of the server 30 determining whether the advertisement item including the image recognized as being identical to the first image exists among the advertisement items stored in the advertisement database 20, since the server 30 preferentially calculates the vector similarity between the advertisement items relatively recently inserted into the advertisement database 20 and the first object, the time for the server 30 to determine whether the advertisement item including the image recognized as being identical to the first image exists may be shortened.

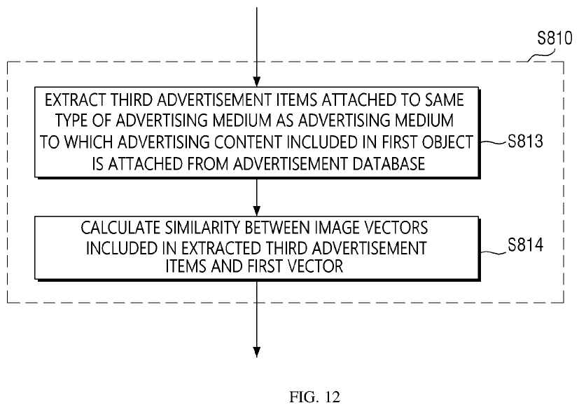

Hereinafter, another method in which the server 30 selects image vectors included in the advertisement items and calculates a similarity between the selected image vectors and the first vector will be described with reference to FIG. 12.

First, the server 30 may receive, from the content collection device 10, information about the type of advertising medium to which the advertising content included in the first object is attached, together with the first image of the first object recognized by inputting the captured image captured by the content collection device 10 into the object recognition model. The type of advertising medium to which the advertising content included in the first object is attached refers to an advertising medium in which the advertising content may be installed, such as a building, a bus shelter, a bus, or a taxi, as described above.

Thereafter, when the server 30 calculates the similarity between image vectors included in the advertisement items and the first vector, the server 30 extracts third advertisement items attached to the same type of advertising medium as the advertising medium to which the advertising content included in the first object is attached from the advertisement database using the received information about the type of advertising medium to which the advertising content included in the first object is attached (S813), and may calculate a similarity between image vectors included in the extracted third advertisement items and the first vector (S814). The content classification information may include the type of advertising medium to which the advertising content included in an advertising type object recognized by the content collection device 10 is attached. Therefore, the type of advertising medium to which the advertising content of the third advertisement item is attached may be identified using the content classification information 95 of the advertising content of the advertisement item included in each advertisement item.

According to the present exemplary embodiment, in the process of the server 30 determining whether the advertisement item including the image recognized as being identical to the first image exists among the advertisement items stored in the advertisement database 20, since the server 30 preferentially calculates the vector similarity between the advertisement items attached to the same type of advertising medium as the type of advertising medium to which the advertising content included in the first object is attached among the advertisement items and the first object, the time for the server 30 to determine whether the advertisement item including the image recognized as being identical to the first image exists may be shortened.

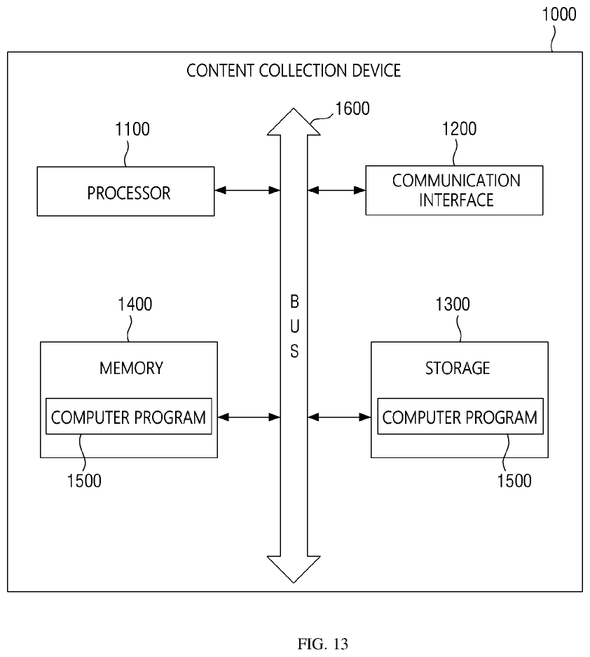

FIG. 13 is a hardware configuration diagram of a computing system according to some exemplary embodiments of the present disclosure. A computing system 1000 of FIG. 13 may include one or more processors 1100, a system bus 1600, a communication interface 1200, a memory 1400 for loading a computer program 1500 executed by the processor 1100, and a storage 1300 for storing the computer program 1500. For example, the computing system of FIG. 13 may be the computing device 11 described with reference to FIG. 1.

The processor 1100 controls the overall operation of each component of the computing system 1000. The processor 1100 may perform a calculation on at least one application or program for executing the methods/operations according to various exemplary embodiments of the present disclosure. The memory 1400 stores various data, instructions, and/or information. The memory 1400 may load one or more programs 1500 from the storage 1300 to execute the methods/operations according to various exemplary embodiments of the present disclosure. The storage 1300 may non-temporarily store one or more computer programs 1500. The computer program 1500 may include one or more instructions in which the methods/operations according to various exemplary embodiments of the present disclosure are implemented. When the computer program 1500 is loaded into the memory 1400, the processor 1100 may perform the methods/operations according to various exemplary embodiments of the present disclosure by executing the one or more instructions.

The computer program 1500 may be a program related to a method for collecting contents.

In some exemplary embodiments, the computer program 1500 may include instructions of performing an operation of acquiring a captured image from the photographing device, an operation of recognizing a first object included in the acquired captured image by inputting the captured image into an object recognition model, wherein the first object is an advertisement type object, an operation of generating first content classification information for the recognized first object, an operation of determining whether the first object has already been reported by using the first content classification information, and transmitting data for the first object to a server when it is determined that the first object is a new object that has not already been reported as a result of performing the determining of whether the first object has already been reported.

In some exemplary embodiments, the computing system 1000 described with reference to FIG. 13 may be configured using one or more physical servers included in a server farm based on a cloud technology such as a virtual machine. In this case, at least some of the processor 1100, the memory 1400, and the storage 1300 among the components illustrated in FIG. 13 may be virtual hardware, and the communication interface 1200 may also be implemented as a virtualized networking element such as a virtual switch.

So far, a variety of embodiments of the present disclosure and the effects according to embodiments thereof have been mentioned with reference to FIGS. 1 to 13. The effects according to the technical idea of the present disclosure are not limited to the forementioned effects, and other unmentioned effects may be clearly understood by those skilled in the art from the description of the specification.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications can be made to the preferred embodiments without substantially departing from the principles of the present disclosure. Therefore, the disclosed preferred embodiments of the disclosure are used in a generic and descriptive sense only and not for purposes of limitation.

What is claimed is:

1. A method for collecting contents performed by a content collection device, the method comprising:
acquiring a captured image;
recognizing a first object included in the acquired captured image by inputting the captured image into an object recognition model, the first object being an advertisement type object;
generating content classification information for the recognized first object;
determining whether the first object has already been reported by using the content classification information; and
transmitting metadata for the first object to a server when it is determined that the first object is a new object that has not already been reported as a result of performing the determining of whether the first object has already been reported.

2. The method of claim 1, wherein the content collection device is mounted on a mobility.

3. The method of claim 1, wherein the content classification information includes a media type of an advertising medium to which advertising content included in the first object is attached, placement information of the advertising content included in the first object on the advertising medium, and a geographical location of the advertising medium.

4. The method of claim 3, wherein placement information of the advertising content included in the first object on the advertising medium indicates a section in the advertising medium to which the advertising content is attached.

5. The method of claim 1, wherein the recognizing of the first object included in the acquired captured image by inputting the captured image into the object recognition model includes identifying a means of transportation to which advertising content included in the first object is attached.

6. The method of claim 5, wherein the identifying of the means of transportation to which the advertising content included in the first object is attached includes:
recognizing a vehicle license plate of the means of transportation; and
identifying the means of transportation by using the result of the recognition.

7. The method of claim 5, wherein the identifying of the means of transportation to which the advertising content included in the first object is attached includes identifying the means of transportation using real-time location information including movement information of the means of transportation.

8. The method of claim 7, wherein the identifying the means of transportation using the real-time location information including the movement information of the means of transportation includes identifying the means of transportation using the real-time location information only when the vehicle license plate of the means of transportation is not recognized.

9. The method of claim 1, wherein the determining of whether the first object has already been reported by using the content classification information includes:
querying an advertisement item stored in an advertisement database;
comparing the metadata for the first object and the advertisement item as a result of performing the querying of the advertisement item; and
determining that the first object has not already been reported only when the metadata for the first object and the advertisement item do not match as a result of performing the comparing of the metadata for the first object and the advertisement item.

10. The method of claim 1, wherein the metadata for the first object includes an image recognized in the first object and the content classification information.

11. A method for analyzing a current status of an advertising market performed by a server, the method comprising:
receiving, from a content collection device, a first image of a first object recognized by inputting a captured image captured by the content collection device into an object recognition model;
extracting a first vector of the first image by inputting the received first image into a content analysis model and using data output from the content analysis model;
determining whether an advertisement item including an image recognized as being identical to the first image exists among advertisement items stored in an advertisement database, using the first vector;
increasing the cumulative number of advertisements for the advertisement item including the image recognized as being identical to the first image, when the advertisement item including the image recognized as being identical to the first image exists; and
generating a new advertisement item including the first image and the first vector and inserting the new advertisement item into the advertisement database, when the advertisement item including the image recognized as being identical to the first image does not exist.

12. The method of claim 11, wherein the determining of whether the advertisement item including the image recognized as being identical to the first image exists among the advertisement items stored in the advertisement database, using the first vector includes:
calculating similarity between image vectors included in the advertisement items and the first vector; and
determining that the advertisement item including the image recognized as being identical to the first image exists, only when a first advertisement item including a vector whose similarity to the first vector is within a preset range among the image vectors included in the advertisement items is identified, as a result of performing the calculating of the similarity.

13. The method of claim 12, wherein the calculating of the similarity between the image vectors included in the advertisement items and the first vector includes:
extracting a preset number of second advertisement items from the advertisement database in the order in which the advertisement items were recently inserted into the advertisement database, among the advertisement items; and
calculating similarity between image vectors included in the extracted second advertisement items and the first vector.

14. The method of claim 12, wherein the receiving of, from the content collection device, the first image of the first object recognized by inputting the captured image captured by the content collection device into the object recognition model includes receiving information about the type of advertising medium to which advertising content included in the first object is attached, and
the calculating of the similarity between the image vectors included in the advertisement items and the first vector includes:
extracting third advertisement items attached to the same type of advertising medium as the advertising medium to which the advertising content included in the first object is attached from the advertisement database by using the received information about the type of advertising medium to which the advertising content included in the first object is attached; and
calculating similarity between image vectors included in the extracted third advertisement items and the first vector.

15. A system for collecting contents, the system comprising:
a photographing device;
a communication interface;
a memory into which a computer program is loaded; and
one or more processors on which the computer program is executed,
wherein the computer program includes instructions for performing:
an operation of acquiring a captured image from the photographing device;
an operation of recognizing a first object included in the acquired captured image by inputting the captured image into an object recognition model, the first object being an advertisement type object;
an operation of generating content classification information for the recognized first object;
an operation of determining whether the first object has already been reported by using the content classification information; and
an operation of transmitting metadata for the first object to a server when it is determined that the first object is a new object that has not already been reported as a result of performing the determining of whether the first object has already been reported.

16. The system of claim 15, wherein the content classification information includes a media type of an advertising medium to which advertising content included in the first object is attached, placement information of the advertising content included in the first object on the advertising medium, and a geographical location of the advertising medium.

17. The system of claim 15, wherein the operation of recognizing the first object included in the acquired captured image by inputting the captured image into the object recognition model includes an operation of identifying a means of transportation to which advertising content included in the first object is attached.

18. The system of claim 17, wherein the operation of identifying the means of transportation to which the advertising content included in the first object is attached includes:
an operation of recognizing a vehicle license plate of the means of transportation; and
an operation of identifying the means of transportation by using the result of the recognition.

19. The system of claim 17, wherein the operation of identifying the means of transportation to which the advertising content included in the first object is attached includes an operation of identifying the means of transportation using real-time location information including movement information of the means of transportation.

20. The system of claim 19, wherein the operation of identifying the means of transportation using the real-time location information including the movement information of the means of transportation includes an operation of identifying the means of transportation using the real-time location information only when the vehicle license plate of the means of transportation is not recognized.
